(19) United States
(12) Patent Application Publication
(10) Pub. No.: US 2008/0098159 A1
(43) Pub. Date: Apr. 24, 2008

(54) Memory system including flash memory and merge method thereof

(75) Inventors: Dong-Hyun Song, Yongin-si (KR); Chan-Ik Park, Seoul (KR); Shea-Yun Lee, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/644,833

(22) Filed: Dec. 26, 2006

(30) Foreign Application Priority Data
Oct. 23, 2006 (KR) 10-2006-0103046

(51) Int. Cl. G06F 12/00

(52) U.S. Cl. 711/103

(57) ABSTRACT

A memory system which includes a host and a data storage device which is configured to receive an invalidated block address and to interrupt a merge operation for an invalidated block.

### PRIORITY STATEMENT

This U.S. non-provisional patent application claims priority under 35 U.S.C §119 of Korean Patent Application 2006-103046 filed on Oct. 23, 2006, the entire contents of which are hereby incorporated by reference.

### BACKGROUND

Example embodiments relate to a data storing device including a flash memory, for example, to a data storing device including a flash memory and a merge method thereof.

In recent years, personal computers such as desktop computers, notebook computers, and the like have become more popular. In general, personal computers may include a main memory and an external storage device. The external storage device may be a hard disk drive (HDD) using a disk storage medium or a floppy disk drive (FDD). In general, such disk storage devices have advantages such as a lower price and a large capacity. On the other hand, because the disk storage devices perform various operations (e.g., disk search operation) using a magnetic head, they are easily damaged by physical impact or have lower reliability than other memory devices.

Data storage devices using semiconductor memories, for example, a flash memory have been developed due to the above-described drawbacks of disk storage devices. A data storage device using a flash memory may consume less power, be more compact, and more robust in response to physical impact.

A host may access a data storage device by providing a logical address thereto. The logical address from the host may be converted into a physical address to access a physical memory space of the data storage device.

In general, a data storage device may necessitate additional software, namely, disk emulation software for ensuring compatibility with a host during an access operation. During the access operation, the compatibility between the host and the data storage device may be accomplished by managing embedded systems, for example, flash translation layer (FTL). In other words, the host may recognize the data storage device as a hard disk to access the data storage device in the same manner as the hard disk.

Functions of the FTL may include logical address-physical address mapping information management, data preservation management due to unexpected power interruption, wear-out management, and the like. Example mapping functions are disclosed in U.S. Pat. No. 5,404,485 entitled “FLASH FILE SYSTEM”, U.S. Pat. No. 5,937,425 entitled “FLASH FILE SYSTEM OPTIMIZED FOR PAGE MODE FLASH TECHNOLOGIES”, AND U.S. Pat. No. 6,381,176 entitled “METHOD OF DRIVING REMAPPING IN FLASH MEMORY AND FLASH MEMORY ARCHITECTURE SUITABLE THEREFOR”, the entire contents of which are hereby incorporated by reference.

In the event that a flash memory is accessed in a block unit, the flash memory may be divided into a plurality of blocks. Numbers sequentially assigned to the divided blocks are called physical block numbers, and virtual numbers of the divided blocks known to a user are called logical block numbers. Techniques for providing mapping between logical block numbers and physical block numbers may include block mapping techniques, sector mapping techniques, and log mapping techniques. In an FTL using a mapping technique, data having logically successive addresses may be stored at physically different places. Because an erase unit is larger than a write (or program) unit, the flash memory may require an operation for collecting successive data, scattered at physically different places, at the same address space using a free block, which may be referred to as a merge operation.

Such a merge operation may be performed using a block mapping technique, a sector mapping technique, and a log mapping technique. Prior to describing the merge operation, it is assumed that a flash memory is divided into a plurality of memory blocks and that each memory block includes a plurality of pages. A symbol PBN indicates a physical block number, a symbol PPN indicates a physical page number, and a symbol LPN indicates a logical page number.

A merge operation according to a conventional block mapping technique will be described with reference to FIG. 1. With the block mapping technique, in case of storing data in any memory block, data may be sequentially stored in pages in the memory block. In case of updating a memory block (e.g., PBN2) whose physical block number is ‘2’, data stored in the remaining pages except a page PPNi where updating is requested, may be copied to corresponding pages of a free memory block (e.g., PBN3). Data to be stored in the page PPNi of a memory block PBN2 may be written in an i^{th} page of the memory block PBN3. Afterwards, the memory block PBN2 may be erased and is assigned to a free memory block. In a block mapping technique, the above-described merge operation may be performed whenever a page, in which data is stored, is updated with new data. Block mapping information between physical block numbers and logical block numbers may be managed using a block mapping table.

A merge operation according to a conventional page mapping technique will be more fully described with reference to FIGS. 2A and 2B. With a page mapping technique, data may be written sequentially in pages of a memory block. Data in a logical page LPN0 may be stored in a physical page PPN0, data in a logical page LPN1 may be stored in a physical page PPN1, and data in a logical page LPN2 may be stored in a physical page PPN2. In case of updating data in a logical page (e.g., LPN1), the data in the logical page LPN1 may be stored in a physical page PPN3. At this time, the physical page PPN0 is treated as a page (in FIG. 2A, marked by ‘X’) where invalid data is stored. If no free page exists in the memory block PBN0, a merge operation may be carried out when a write operation is requested to the memory block PBN0. As illustrated in FIG. 2A, valid data of the memory block PBN0, that is, physical pages PPN2-PPN5 may be copied to corresponding pages PPN10-PPN13 of a free memory block PBN1, and data of a logical page LPN0, in which a write operation is requested, may be stored in a physical page PPN14 of the memory block PBN1. At this time, the physical page PPN10 of the memory block PBN1 may be treated as a page (in FIG. 2A, marked by ‘X’) where invalid data is stored. Afterwards, the memory block PBN0 may be erased. A changed mapping table is managed by FTL as illustrated in FIG. 2B.

A merge operation according to a conventional log mapping technique will be more fully described with reference to FIGS. 3A and 3B. Referring to FIG. 3A, in a data storage device, a flash memory may be divided into a data region, a log region, and a meta region.

With a log mapping technique, memory blocks in the log region may be assigned to any memory blocks in the data region, respectively. For example, it may be assumed that a flash memory includes nine memory blocks PBN0-PBN8. Among the memory blocks, memory blocks PBN0-PBN4 are defined as the data region, memory blocks PBN5-PBN7 are defined as the log region, and memory blocks PBN8 are defined as the meta region. In this case, it may be assumed that the memory blocks PBN5 and PBN6 in the log region are assigned to the memory blocks PBN0 and PBN2 in the data region, respectively, and that the memory block PBN7 in the log region is assigned to a free memory block.

In case of writing data in the memory block PBN0 of the data region, the data is written not directly in the memory block PBN0 but in the memory block PBN5 of the log region corresponding to the memory block PBN0. In the event that data is written in the memory block PBN1, the following merge operation may be carried out because there is no memory block of the log region corresponding to the memory block PBN1.

If a free memory block PBN7 exists in the log region, valid data stored in the memory block of the log region may be copied to a free memory block PBN7. Copied to the memory block PBN7 is valid data stored in the memory block PBN0 of the data region corresponding to the memory block PBN5.

Mapping information of memory blocks according to the merge operation may be changed. The changed mapping information may be managed by the FTL, and may be stored in the meta region (e.g., PBN8) of the flash memory.

Referring to FIG. 3B which shows a merge operation according to a log mapping technique, valid pages in the log block PBN5 and the data block PBN0 may be copied to a new data block PBN7. Because data in the log block PBN5 is recently written data, it has a higher possibility that a user wants to be written. On the other hand, data written in the data block PBN0 has a higher possibility that it is erased data, that is, invalid data. In this case, the FTL does not know whether data written in the data block PBN0 is valid or invalid. That is, valid pages in the data block PBN0 can be valid pages from the FTL viewpoint, while they can be invalid pages from the FTL viewpoint. For example, if a file written in a second valid page of the data block PBN0 is previously erased in a file system level, a merge operation for the page may be an unnecessary operation from the file system viewpoint.

Because a merge operation is an operation carried out according needs of the FTL, the host does not know whether the merge operation is caused. In case of a conventional data storage device, the FTL does not know whether a page in a data block being a target of a merge operation is valid from the file system viewpoint. This is because the FTL does not refer to information of a file system. This means that the FTL performs a merge operation when data exists at a corresponding page without checking the validity with respect to the corresponding page of a data block. Accordingly, a merge operation of a conventional data storage device may cause waste of unnecessary time because data deleted in a file system level is copied.

### SUMMARY OF THE INVENTION

Example embodiments are directed to a memory system which may include a host and a data storage device which is configured to receive an invalidated block address and to interrupt a merge operation for an invalidated block.

Example embodiments are directed to a memory system further comprising a software module which detects the invalidated block address in response to a file process command from the host.

Example embodiments are directed to a memory system wherein the file process command includes a file delete command.

Example embodiments are directed to a memory system, wherein the data storage device comprises a NAND flash memory which stores data and a controller which receives the invalidated block address and performs the merge operation.

Example embodiments are directed to a memory system, wherein the NAND flash memory includes a FAT region, a data region, a log region, and a meta region.

Example embodiments are directed to a memory system, wherein if a file stored in the data region, the controller merges a memory block storing the deleted file with a new data block.

Example embodiments are directed to a memory system, wherein the controller includes a work memory which stores a flash translation layer for performing the merge operation.

Example embodiments are directed to a memory system, wherein the NAND flash memory and the controller are integrated in a card.

Example embodiments are directed to a memory system, wherein the data storage device includes a NAND flash memory which stores data and a controller which receives the invalidated block address and performs the merge operation, the NAND flash memory including a file allocation table (FAT) region wherein the controller detects the invalidated block address in response to file allocation table (FAT) information stored in the file allocation table (FAT) region.

Example embodiments are directed to a merge method of a memory system including a flash memory, the merge method including detecting an address of an invalidated block in the flash memory in response to a file process command from a host and interrupting a merge operation for the invalidated block, based on the invalidated block address.

Example embodiments are directed to a merge method, wherein detecting the address of the invalidated block in the flash memory is based on file allocation table (FAT) information.

Example embodiments are directed to a merge method, further comprising receiving a file process command from a host, wherein detecting the address of the invalidated block in the flash memory is in response to the file process command.

Example embodiments are directed to a merge method, wherein the file process command includes a file delete command.

Example embodiments are directed to a merge method, wherein the flash memory is a NAND flash memory.

Example embodiments are directed to merge method of a memory system including a flash memory, the merge method including identifying an address of a block as either valid or invalid and performing a merge operation on the valid address blocks and not on the invalid address blocks.

Example embodiments are directed to merge method, wherein identifying the address of the block as either valid or invalid is based on file allocation table (FAT) information.

Example embodiments are directed to merge method wherein identifying the address of the block as either valid or invalid is in response to a file process command.

### BRIEF DESCRIPTION OF THE DRAWINGS

FIG. 1 is a diagram for describing a conventional page mapping method.

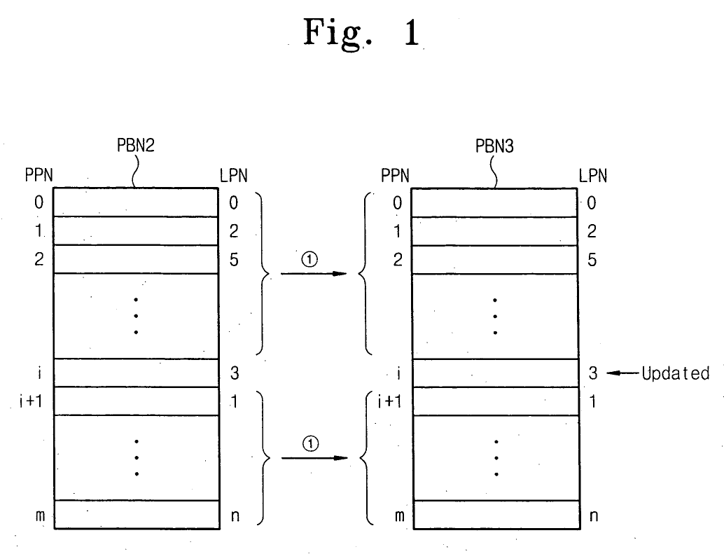

FIGS. 2A and 2B are diagrams for describing a conventional block mapping method.

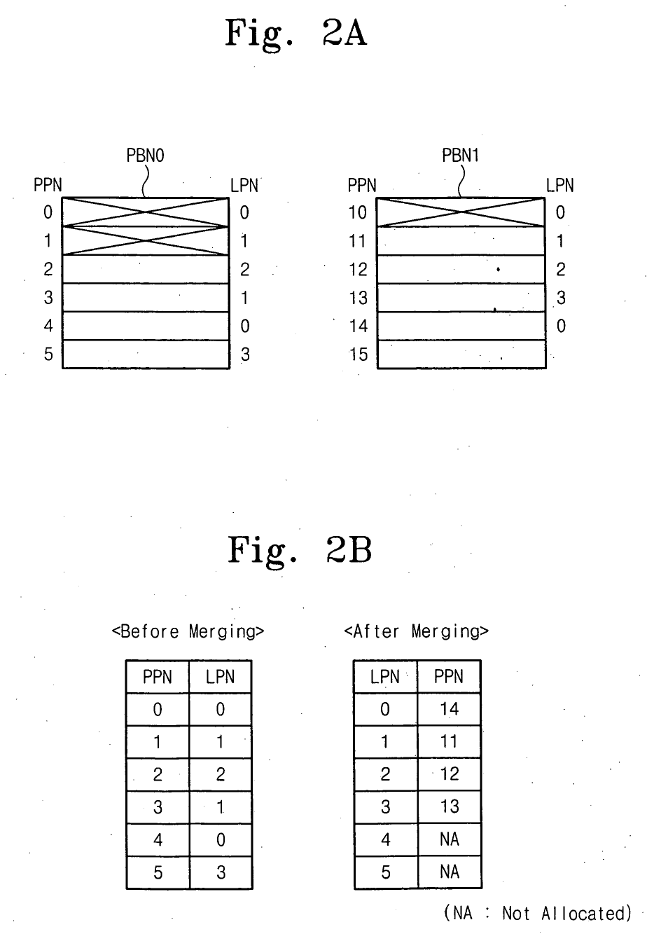

FIGS. 3A and 3B are diagrams for describing a conventional log mapping method.

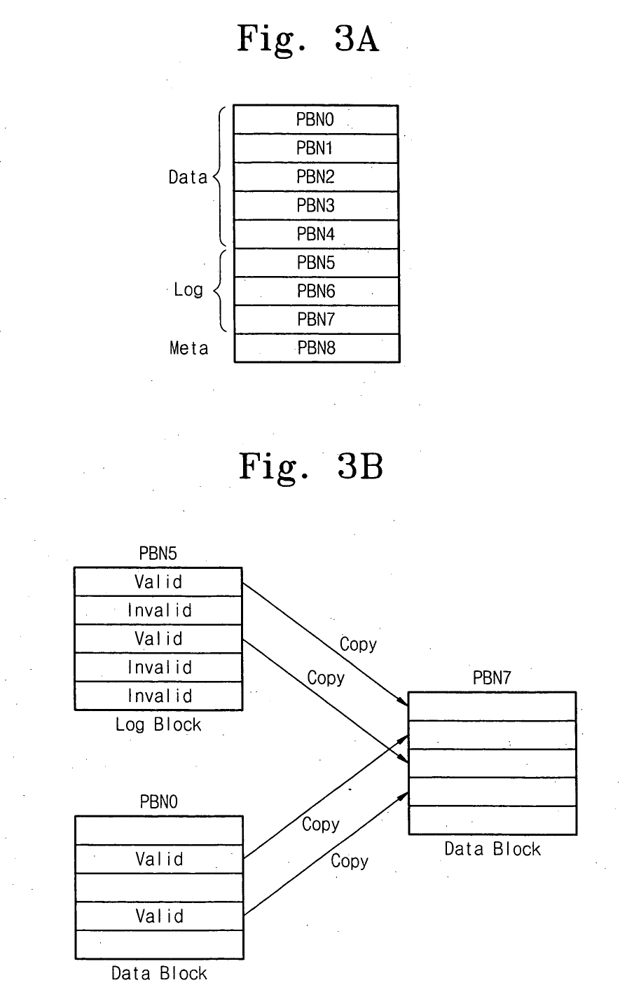

FIG. 4 is a block diagram showing a memory system including a flash memory.

FIG. 5 is a conceptual diagram for describing a merge method of a data storage device illustrated in FIG. 4.

FIG. 6 is a flowchart for describing a selective merge operation of a memory system illustrated in FIG. 4.

FIG. 7 is a block diagram showing a memory system according to example embodiments.

FIG. 8 is an example conceptual diagram showing a block merge method of a memory system illustrated in FIG. 7.

### DETAILED DESCRIPTION OF EXAMPLE EMBODIMENTS

Example embodiments of the present invention will be more clearly understood from the detailed description taken in conjunction with the accompanying drawings.

Various example embodiments of the present invention will now be described more fully with reference to the accompanying drawings in which some example embodiments of the invention are shown. In the drawings, the thicknesses of layers and regions may be exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

Also, the use of the words “compound,” “compounds,” or “compound(s),” refer to either a single compound or to a plurality of compounds. These words are used to denote one or more compounds but may also just indicate a single compound.

Now, in order to more specifically describe example embodiments of the present invention, various embodiments of the present invention will be described in detail with reference to the attached drawings. However, the present invention is not limited to the example embodiments, but may be embodied in various forms. In the figures, if a layer is formed on another layer or a substrate, it means that the layer is directly formed on another layer or a substrate, or that a third layer is interposed therebetween. In the following description, the same reference numerals denote the same elements.

Although the example embodiments of the present invention have been disclosed for illustrative purposes, those skilled in the art will appreciate that various modifications, additions and substitutions are possible, without departing from the scope and spirit of the invention as disclosed in the accompanying claims.

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

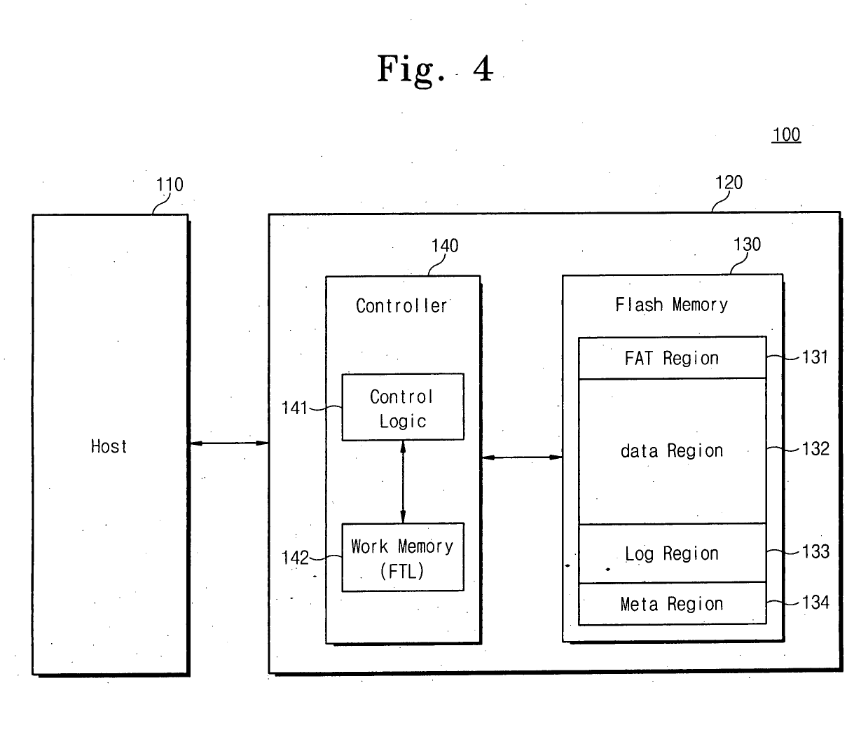

FIG. 4 is a block diagram showing a memory system including a flash memory. A memory system 100 illustrated in FIG. 4 may include a host 110 and a data storage device 120. The host 110 may recognize the data storage device 120 as a storage medium that performs read, write and erase operations without limitation, for example, a hard disk.

The data storage device 120 may include a NAND flash memory 130 and a controller 140. The NAND flash memory 130 may store data, and the controller 140 may provide an interface between the host 110 and the NAND flash memory 130.

The NAND flash memory 130 may include of a plurality of memory cells having a string structure, which is well known in the art. A group of the memory cells is called a memory cell array, which is divided into a plurality of memory blocks. Each of the memory blocks may include a plurality of pages each of which may include memory cells configured to share a word line.

The NAND flash memory 130 may perform read and operations and an erase operation in different units. That is, for example, the NAND flash memory 130 may perform an erase operation in a memory block unit and the read and write operations in a page unit. The NAND flash memory 130 may not support an overwrite operation unlike other semiconductor memory devices. Accordingly, the NAND flash memory 130 may require an erase operation before a write operation. For this reason, the data storage device 120 may require additional management for read, write and erase operations in order to use it like a hard disk, which may be implemented by a flash translation layer FTL, in the form of system software.

The NAND flash memory 130, as illustrated in FIG. 4, may include a file allocation table (FAT) region 131, a data region 132, a log region 133, and/or a meta region 134. Stored in the FAT region 131 may be FAT information.

In case of writing data in a block of the data region 132, the data may not be written directly in the data block but in a corresponding block of the log region 133. If a log block in the log region 133 is not assigned to a data block in the data region 132 or if there is a request from the host 110, a merge operation may be carried out. With the merge operation, valid pages in log and data blocks may be copied to a new data or log block. The merge operation may cause a change in mapping information, which is stored in the meta region 134.

The controller 140 may be configured to control the NAND flash memory 130 in response to an access request from the host 110. As illustrated in FIG. 4, the controller 140 may include control logic 141 and/or a work memory 142. The word memory 142 may include flash translation layer FTL, and the controller 141 may drive the flash translation layer FTL in the work memory 142 in response to an access request from the host 110.

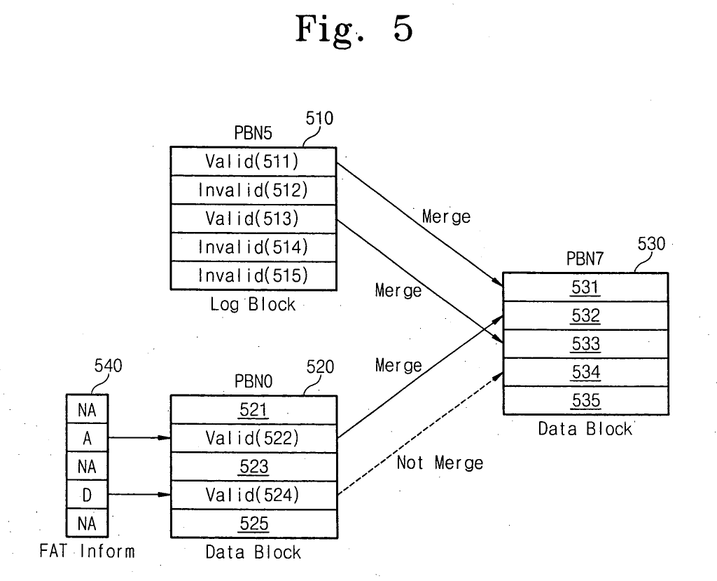

FIG. 5 is a conceptual diagram for describing a merge method of a data storage device illustrated in FIG. 4. Referring to FIG. 5, valid pages 511 and 513 in a log block 510 and a valid page 522 in a data block 520 may be copied to a new data block 530. The first and third valid pages 511 and 513 in the log block 510 may be copied in first and third pages 531 and 533 in the new data block 530. The second valid page 522 in the data block 520 may be copied in a second page 532 in the new data block 530.

A merge method of the data storage device according to example embodiments may be configured to selectively copy valid pages in the data to the new data block 530 with reference to FAT information 540.

Referring to FIG. 5, the FAT information 540 in a flash memory 130 (shown in FIG. 4) may store information with respect to whether or not a page in the data block 520 is allocated. A symbol ‘NA’ may indicate an unallocated page, a symbol ‘A’ may indicate an allocated page, and a symbol ‘D’ may indicate a page which is deleted at a file system level and in which a file is stored.

For example, because a first page 521 in the data block 520 is a page which is not used to store a file, it may be marked by ‘NA’ in the FAT information 540. Because a second page 522 in the data block 520 is a valid page which is used to use a file, it may be marked by ‘A’ in the FAT information 540. Third and fifth pages 523 and 525 in the data block 520 are marked by ‘NA’ in the FAT information 540. a fourth page in the data block 520 is marked by ‘D’ in the FAT information 540 because it is deleted in a file system level.

Although data in the fourth page 524 of the data block 520 is valid data, it is a page which is deleted in a file system level, that is, an invalid page. Accordingly, if the fourth page 524 in the data block 520 has data deleted in the file system level, data of the fourth page 524 is not copied to a new data block 530.

Accordingly, the merge operation according to example embodiments may prevent invalid data from being copied with reference to the FAT information. This means that a time needed for a merge operation may be reduced by performing no merge operation on pages which are unnecessary in a file system.

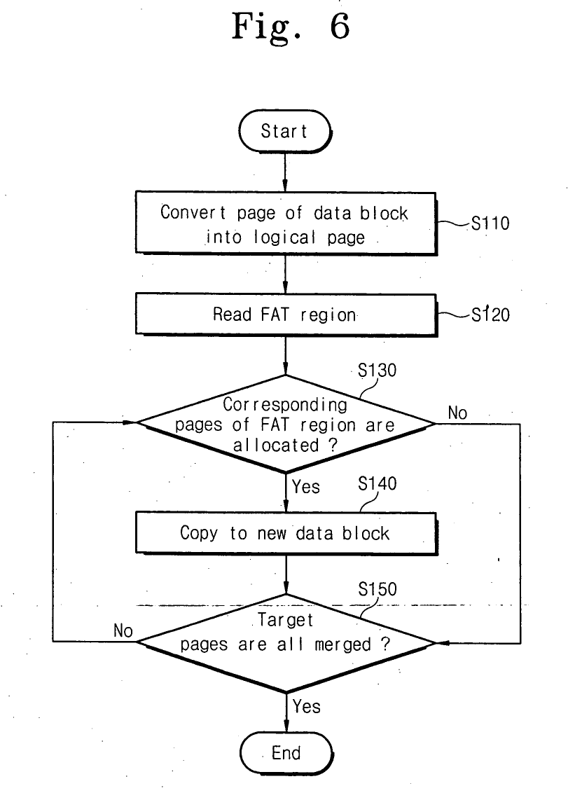

FIG. 6 is a flowchart for describing a selective merge operation of a memory system illustrated in FIG. 4. A selective merge operation of a memory system according to example embodiments will be more fully described with reference to accompanying drawings.

At S110, a physical page of a new data block 530 (refer to FIG. 5) may be converted into a logical page. At S120, flash translation layer FTL may read FAT information of a flash memory 130 (refer to FIG. 4)

At S130, there is determined whether a corresponding page of a data block is a valid page to be copied. That is, there is determined whether a corresponding page of a FAT region is allocated to store a file. If it is determined the corresponding page to be an invalid page, it is not copied to the new data block and the procedure proceeds to S150.

At S140, if a corresponding page of a data block is a valid page where a file is stored, it is copied to a new data block. At S150, there is checked whether target pages are all merged. If not, the procedure proceeds to S130. If so, the procedure is ended.

As understood from the above description, it is possible to reduce a time needed for a merge operation by preventing copying of data that is invalid or deleted in a file system. As well known in the art, it takes much time to copy page data of data blocks. Accordingly, it is possible to reduce a time needed for a merge operation by selectively copying pages in a data block.

For example, it is assumed that a log block includes x valid pages, that a data block includes y pages including data, and that a time needed to copy one page is z. A total time needed for a merge operation is (x+y)*z. If i pages are deleted in a file system level, a time of i*Z among a time needed for a merge operation is unnecessary time. Accordingly, a reduced time for a merge operation according to example embodiments is (i*z—(a time needed to read FAT region)).

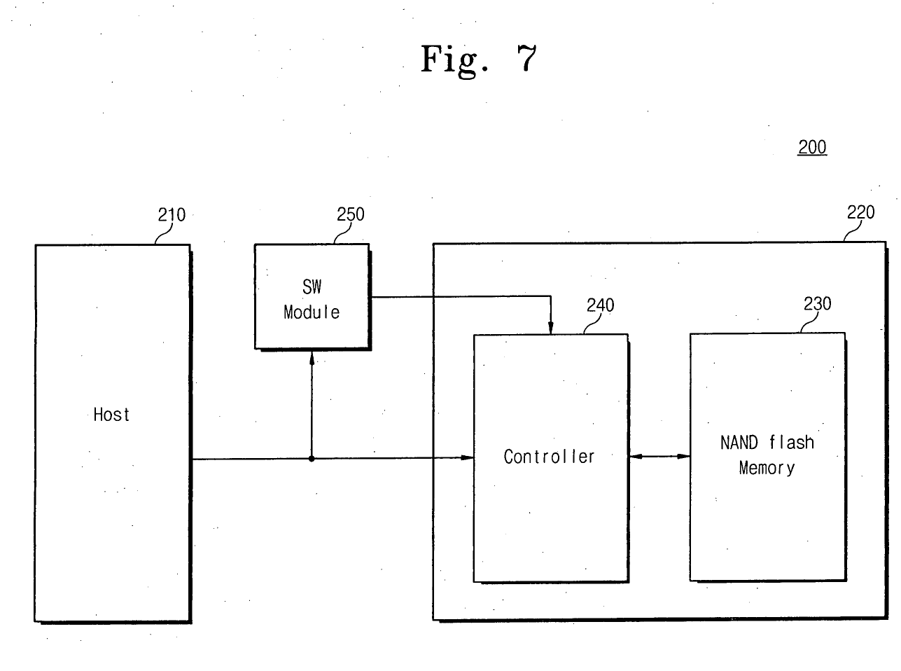

FIG. 7 is a block diagram showing a memory system according to example embodiments. A memory system in FIG. 4 may determine memory blocks to be merged based on FT|AT information in a FAT region 131 of a NAND flash memory 130 at a merge operation. With the memory system in FIG. 4, it is possible to reduce an unnecessary merge time.

A memory system in FIG. 7 is configured to determine memory blocks to be merged based on a file process command applied from a host 210. Referring to FIG. 7, the memory system 200 may include a host 210, a data storage device 220, and a software module 250. The constituent elements 230 and 240 may be identical to those in FIG. 4.

The host 210 may provide a file process command to the data storage device 220. The file process command may include a file delete command. The software module 250 may detect an invalidated logical block address LBA based on a file delete command generated from the host 210. The software module 250 may provide the detected invalidated LBA to a controller 240 in the data storage device 220.

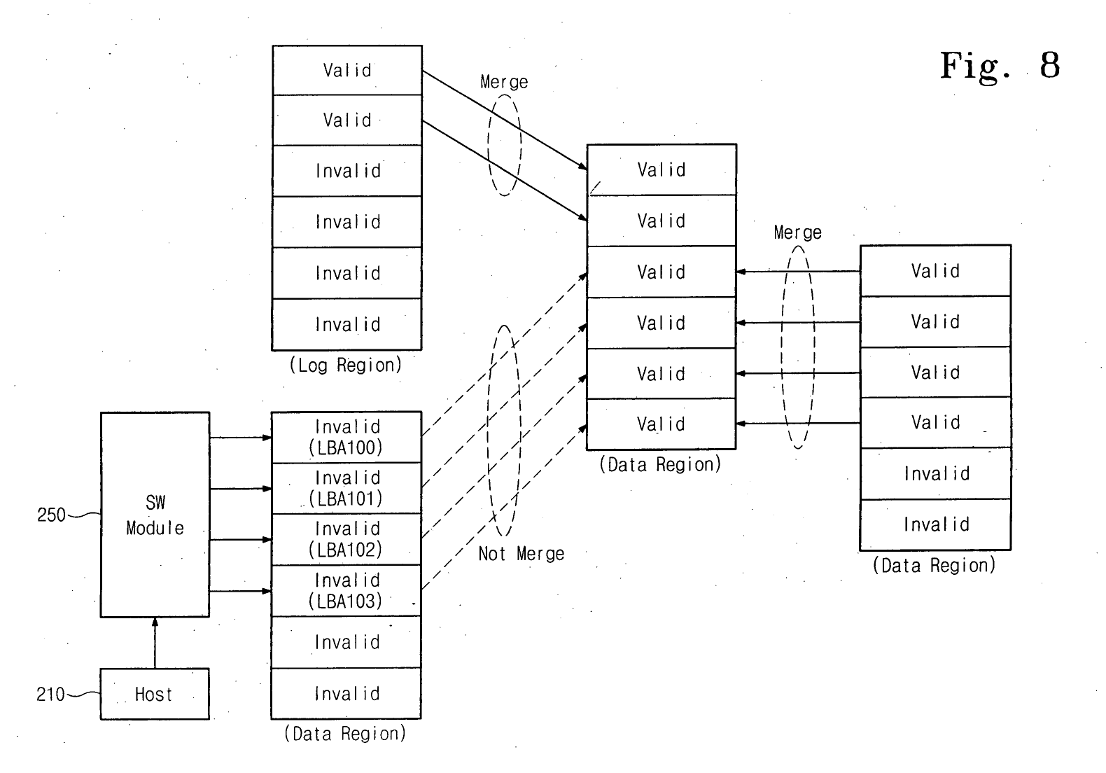

FIG. 8 is an example conceptual diagram showing a block merge method of a memory system illustrated in FIG. 7. Referring to FIG. 8, a software module 250 may receive a file delete command from a host 210. The software module 250 may detect an invalidated logical block address from the file delete command.

For example, referring to FIG. 8, an invalidated logical block address LBA may include LBA100 to LBA103. A controller 240 in FIG. 7 may input an invalidated logical block address LBA from the software module 250 to interrupt a merge operation of a corresponding block at a block merge operation.

As understood from the above description, the memory system in FIG. 7 may detect an invalidated memory block based on a file process command from a host and does not perform a merge operation with respect to the invalidated memory block. Accordingly, it is possible to reduce a time needed for a merge operation.

Although example embodiments set forth above refer to flash memory, any other memory may also be utilized, as would be known to one of ordinary skill in the art.

In example embodiments, the NAND flash memory and the controller are integrated in a card.

Although example embodiments have been described in connection with the accompanying drawings, they are not limited thereto. It will be apparent to those skilled in the art that various substitution, modifications and changes may be thereto without departing from the scope and spirit of the appended claims.

What is claimed is:

1. A memory system comprising:
a host; and
a data storage device which is configured to receive an invalidated block address and to interrupt a merge operation for an invalidated block.

2. The memory system of claim 1, further comprising:
a software module which detects the invalidated block address in response to a file process command from the host.

3. The memory system of claim 2, wherein the file process command includes a file delete command.

4. The memory system of claim 1, wherein the data storage device comprises:
a NAND flash memory which stores data; and
a controller which receives the invalidated block address and performs the merge operation.

5. The memory system of claim 4, wherein the NAND flash memory includes a FAT region, a data region, a log region, and a meta region.

6. The memory system of claim 5, wherein if a file stored in the data region, the controller merges a memory block storing the deleted file with a new data block.

7. The memory system of claim 4, wherein the controller includes a work memory which stores a flash translation layer for performing the merge operation.

8. The memory system of claim 4, wherein the NAND flash memory and the controller are integrated in a card.

9. The memory system of claim 1, wherein the data storage device comprises:
a NAND flash memory which stores data; and
a controller which receives the invalidated block address and performs the merge operation,
the NAND flash memory including a file allocation table (FAT) region wherein the controller detects the invalidated block address in response to file allocation table (FAT) information stored in the file allocation table (FAT) region.

10. A merge method of a memory system including a flash memory, the merge method comprising:
detecting an address of an invalidated block in the flash memory in response to a file process command from a host; and
interrupting a merge operation for the invalidated block, based on the invalidated block address.

11. The merge method of claim 10, wherein detecting the address of the invalidated block in the flash memory is based on file allocation table (FAT) information.

12. The merge method of claim 11, further comprising:
receiving a file process command from a host;
wherein detecting the address of the invalidated block in the flash memory is in response to the file process command.

13. The merge method of claim 12, wherein the file process command includes a file delete command.

14. The merge method of claim 12, wherein the flash memory is a NAND flash memory.

15. A merge method of a memory system including a flash memory, the merge method comprising:
identifying an address of a block as either valid or invalid;
performing a merge operation on the valid address blocks and not on the invalid address blocks.

16. The merge method of claim 15, wherein identifying the address of the block as either valid or invalid is based on file allocation table (FAT) information.

17. The merge method of claim 15, wherein identifying the address of the block as either valid or invalid is in response to a file process command.
